(19) United States
(12) Patent Application Publication
(10) Pub. No.: US 2006/0278858 A1
(43) Pub. Date: Dec. 14, 2006

(54) Self locking hydraulic jack

(76) Inventor: Virgil D. Brocchini JR., Madera, CA (US)

Correspondence Address: JAMES RAY & ASSOCIATES, 2640 PITCAIRN ROAD, MONROEVILLE, PA, 15146, US

(21) Appl. No.: 11/204,695

(22) Filed: Aug. 16, 2005

Related U.S. Application Data
(63) Continuation-in-part of application No. 11/151,767, filed on Jun. 14, 2005.

(51) Int. Cl. B60P 1/48

(52) U.S. Cl. 254/8 B

(57) ABSTRACT

A locking device for a hydraulic floor jack includes a base member attached to a pair of spaced side plates of such jack. An elongated ratchet member is mounted for linear movement within the base member and is attached to a piston rod of a hydraulic cylinder and to a load lifting linkage. A shaft is pivotally mounted to the base member and a holding pawl is secured to the shaft for rotation therewith. The holding pawl is engageably cooperative with the ratchet member for retaining such load lifting linkage in the elevated position upon termination of a manual actuating effort. A release foot pedal or a release lever is connected to the shaft and manually operable to at least move the holding pawl away from engagement with the ratchet member and enable movement of the load lifting linkage into the lowered position.

### CROSS-REFERENCE TO RELATED APPLICATIONS

This application is a Continuation-In-Part of U.S. patent application Ser. No. 11/151,767 filed on Jun. 14, 2005, now abandoned.

### FIELD OF THE INVENTION

The present invention relates, in general, to floor jacks and, more particularly, this invention relates to a locking mechanism for preventing unintentional descent of a load lifting mechanism in a hydraulic floor jack.

### BACKGROUND OF THE INVENTION

As is generally well known, floor jacks of various types are utilized extensively for lifting automotive vehicles during repair efforts or lifting other loads. One type of a commonly used jack includes a pair of spaced side plates, a load lifting linkage mechanism supported and disposed for pivotal movement between such pair of side plates, such linkage mechanism is movable from a lowered position to an elevated position for engaging and elevating a load. A hydraulic drive assembly is connected to such linkage mechanism for moving such linkage mechanism towards such elevated position upon actuation of such drive assembly and for moving such linkage mechanism towards such lowered position upon deactuation of such drive assembly. A manually operable control handle is provided for actuating and deactuating the hydraulic drive assembly. Such hydraulic drive assembly includes a hydraulic cylinder having a piston member mounted for linear movement therein and a piston rod attached to the piston member and extending outwardly from such hydraulic cylinder for connection to such linkage mechanism. A pump assembly is connected in fluid communication with the hydraulic cylinder and is removably connected to a control handle. Manual operation of the control handle delivers fluid from such pump assembly to such hydraulic cylinder causing movement of such piston rod in a first direction and enabling movement of such linkage mechanism to such elevated position. Rotation of the control handle or of the additional knob discharges such fluid from the hydraulic cylinder causing movement of such piston rod in a second direction and enabling movement of such linkage mechanism to the lowered position.

It is essential to prevent such lifting linkage mechanism from unintentionally moving into such lowered position, due to failure of the hydraulic drive means, as such condition may cause injuries to persons using such floor jacks. Additionally, using the hydraulic drive mechanism to retain the linkage mechanism in the elevated position provides undesirable stresses on hydraulic components causing premature wear and reduced operating life.

Efforts have been made to provide independent locking arrangements for retaining the lifting linkage mechanism in the elevated position without the use of the hydraulic drive.

U.S. Pat. No. 5,221,073 to Shockey discloses a bar manually insertable through opposingly aligned pairs of notches in the side plates to block downward movement of the linkage mechanism.

U.S. Pat. No. 5,984,270 to Hussaini et al teaches a block fixed to the lifting linkage mechanism and a lock rod manually inserted through horizontal holes in the block to provide abutment across the two side plates.

The main disadvantage of the prior art locking devices is that their operation requires a person to reach under the lifted load in order to actuate or deactuate such locking means, exposing the person to hazards or injuries during such effort.

Therefore, there is a need for a remotely operable locking device for a floor jack that prevents the lifting linkage mechanism from unintentionally moving into the lowered position.

### SUMMARY OF THE INVENTION

The invention provides a locking device for a hydraulic floor jack having a pair of spaced side plates and a load lifting linkage mechanism supported and disposed for pivotal movement between such pair of side plates, such linkage mechanism is movable from a lowered position to an elevated position for engaging and elevating a load. A drive assembly is connected to such linkage mechanism for moving such linkage mechanism towards such elevated position upon actuation of the drive assembly and for moving such linkage mechanism towards such lowered position upon deactuation of the drive assembly. A manually operable control handle is provided for actuating and deactuating the drive assembly. Such drive assembly includes a hydraulic cylinder having a piston member mounted for linear movement therein and a piston rod attached to the piston member and extending outwardly from such hydraulic cylinder for connection to such linkage mechanism. A pump assembly is connected in fluid communication with the hydraulic cylinder and is removably connected to the control handle. Manual operation of the control handle delivers fluid from such pump assembly to such hydraulic cylinder causing movement of such piston rod in a first direction and enabling movement of the linkage mechanism to such elevated position. Rotation of the control handle or the additional knob discharges the fluid from such hydraulic cylinder causing movement of the piston rod in a second direction and enabling movement of the linkage mechanism to the lowered position. The locking device includes a base member attached to the pair of spaced side plates. An elongated ratchet member is mounted for linear movement within the base member and is attached to a piston rod and to a load lifting linkage mechanism. A shaft is pivotally mounted to the base member and a holding pawl is secured to the shaft for rotation therewith. The holding pawl is engageably cooperative with the ratchet member for retaining such load lifting linkage mechanism in the elevated position upon termination of a manual actuating effort. A release foot pedal or a release lever is connected to the shaft and manually operable to at least move the holding pawl away from engagement with the ratchet member and enable movement of the load lifting linkage mechanism into the lowered position.

### OBJECTS OF THE INVENTION

It is, therefore, one of the primary objects of the present invention to provide a locking device for a floor jack in order to prevent unintentional lowering of the load lifting linkage mechanism raised to an elevated position.

Another object of the present invention is to provide a locking device for a floor jack which is remotely operable.

Yet another object of the present invention is to provide a locking device for a floor jack which is operable independently from the drive mechanism.

A further object of the present invention is to provide a locking device for a floor jack which is self locking.

Yet a further object of the present invention is to provide a locking device for a floor jack which is economical to manufacture.

An additional object of the present invention is to provide a locking device for a floor jack which is easily installed onto presently used floor jacks.

In addition to the several objects and advantages of the present invention which have been described with some degree of specificity above, various other objects and advantages of the invention will become more readily apparent to those persons who are skilled in the relevant art, particularly, when such description is taken in conjunction with the attached drawing Figures and with the appended claims.

### BRIEF DESCRIPTION OF THE DRAWINGS

FIG. 1 is a perspective view of the prior art hydraulic floor jack apparatus;

FIG. 2 is a partial plan view of the hydraulic floor jack apparatus of the present invention, particularly showing the locking mechanism;

FIG. 3 is a partial cross-section view of the locking mechanism along lines 3-3 of FIG. 2;

FIG. 4 is a partial side elevation view of the hydraulic floor jack apparatus of the present invention, particularly showing the release mechanism of one embodiment; and

FIG. 5 is a partial side elevation view of the floor hydraulic jack apparatus of the present invention, particularly showing the release mechanism of another embodiment.

### BRIEF DESCRIPTION OF THE VARIOUS EMBODIMENTS OF THE INVENTION

Prior to proceeding to the more detailed description of the present invention, it should be noted that, for the sake of clarity and understanding, identical components which have identical functions have been identified with identical reference numerals throughout the several views illustrated in the drawing figures.

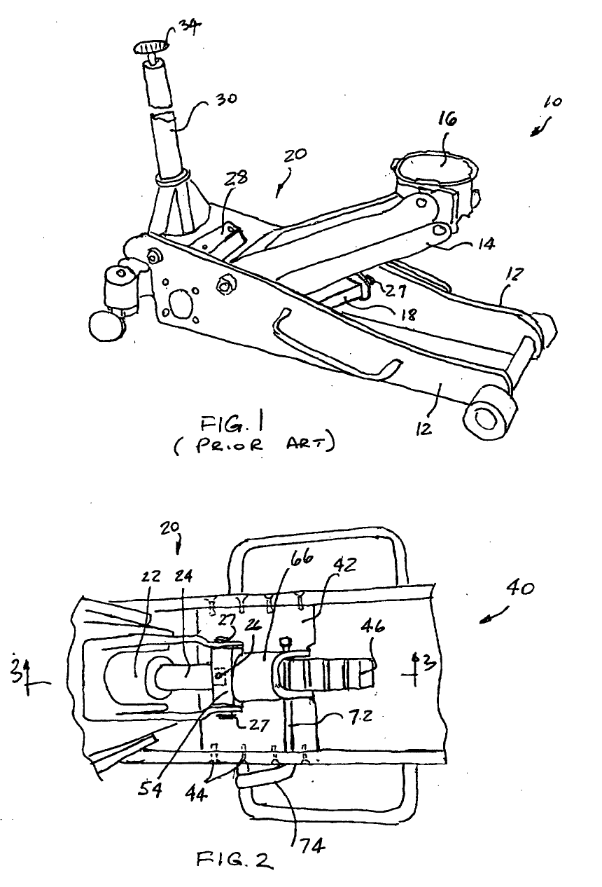

Reference is now made, to FIGS. 1-5, wherein there is shown a hydraulic floor jack, generally designated 10, for lifting a load. Such jack 10 includes a pair of spaced side plates 12 and a linkage means 14 supported and disposed for pivotal movement between such pair of side plates 12. A lifting plate 16 is securely attached to the free end of the linkage means 14. The linkage means 14 is movable from a lowered position to an elevated position to enable the lifting plate 16 to engage and elevate the load (not shown). A drive means, generally designated 20, is connected to such linkage means 14 for moving such linkage means 14 towards such elevated position upon actuation of such drive means 20 and for moving such linkage means 14 towards such lowered position upon deactuation of such drive means 20.

The drive means 20 includes a hydraulic cylinder 22 having a piston member (not shown) mounted for linear movement therein and a piston rod 24 attached to the piston member (not shown) which extends outwardly from such hydraulic cylinder 22 for connection to a member 18 of such linkage means 14 with a retaining pin 26, best shown in FIG. 3. A pump assembly 28 is connected in fluid communication with the hydraulic cylinder 22 and is removably connected to the control means 30, such as a handle 30, for manually actuating and deactuating such drive means 20. It will be understood that a manual actuation effort characterized by a repetitive manual raising and lowering of the handle 30 delivers fluid from such pump assembly 28 to such hydraulic cylinder 22, generating fluid pressure onto the piston (not shown), causing movement of such piston rod 24 in a first direction, which is away from the handle 30 in FIG. 1, and enabling movement of the linkage means 14 to such elevated position. Manual rotation of the handle 30 discharges such fluid pressure from the hydraulic cylinder 22 causing movement of such piston rod 24 in a second direction, which is towards the handle 30 in FIG. 1, and enabling movement of the linkage means 14 to such lowered position.

Alternatively, a rotating knob 34 attached to an open end of the handle 30 may be provided for discharging the fluid from the hydraulic cylinder 22.

When the load (not shown) is elevated to a predetermined position, the fluid pressure generated in the cylinder 22 prevents lowering of the linkage means 14 and, more importantly, prevents unintentional lowering of the load (not shown) until rotation of the handle 30 or the knob 34 discharges such fluid pressure form the hydraulic cylinder 22 and enables the piston rod 24 to move in the second direction.

As such operating condition exerts undesirable forces onto the hydraulic cylinder 22 and its various members, a locking mechanism, generally designated 40, is provided for retaining such linkage means 14 in the elevated position upon termination of the manual actuating effort and for preventing unintentional movement of such linkage means 14 into such lowered position upon discharging of the fluid pressure from the hydraulic cylinder 22 and deactivation of such drive means 20.

Such locking device 40 includes a base member 42 attached to each of such pair of spaced side plates 18, preferably with a plurality of fasteners 44. Alternatively, such base member 42 may be rigidly attached by welding or may be integral to the pair of spaced side plates 12. To retain the linkage means 14 in the elevated position, the locking device 40 has an elongated ratchet means 46 mounted for linear movement within the base member 42 and engageable with one of a predetermined portion of such drive means 20, such linkage means 14 and a combination thereof for movement therewith. In the presently preferred embodiment of the invention, the ratchet means 46 is a rack 46 having a plurality of teeth 48 each having a predetermined shape defined by a sloping front surface 50 and a substantially vertical back surface 52. A mounting portion 54 is provided for attachment to the piston rod 24 with the retaining pin 26 and for attachment to the linkage means 14 with a pair of retaining clips 27, all presently used for attachment of the piston rod 24 to the linkage means 14

A holding pawl 60 is engageably cooperative with such plurality of teeth 48 of the ratchet means 46 for at least retaining such linkage means 60 in such elevated position upon termination of the manual actuating effort. Such holding pawl 60 is rigidly attached to the shaft 62 for rotation therewith. The shaft 62 may be pivotally mounted to the pair of side plates 12, but is preferably mounted to a U-shaped member 66 rigidly attached to the base member 42 and preferably being integral to such base member 42. A bias means 64, such as a bias spring 64, may be provided for urging such holding pawl 60 into engagement with the ratchet means 46.

It is further preferred that the plurality of teeth 48 are faced in a position to enable the holding pawl 60 to pivot in a substantially vertical plane and engage the ratchet means 46.

In operation, while the load (not shown) is being lifted, the holding pawl 60 ratchets on the sloped front surface 50 of a portion of the plurality of teeth 48. When the load (not shown) is lifted to a predetermined elevated position, holding pawl 60 will abut the substantially vertical back surface 52 of a corresponding tooth 48 providing for retainment of the linkage means 14 independently from the drive means 20 and enabling discharge of the fluid pressure from the hydraulic cylinder 22. Such substantially vertical back surface 52 will prevent movement of the piston rod 24 towards the handle 30 which is associated with the lowering of the linkage means 14. It will be appreciated that such locking device 40 will prevent unintentional movement of such linkage means 14 into such lowered position upon discharging of the fluid pressure from the hydraulic cylinder 22 and deactivation of such drive means 20.

To enable movement of such linkage means 14 into such lowered position under normal operating conditions, the locking device 40 is provided with a release means, generally designated 70, which includes an elongated member 72 extending from the shaft 62 and having a predetermined portion 74 protruding beyond at least one of such pair of spaced side plates 12. Preferably, at least the elongated member 72 is integral to the shaft 62.

To release the locking device 40 and lower the load (not shown), first, the handle 30 is manually operated to lift the load (not shown) and release force acting on engagement of such holding pawl 60 with the ratchet means 46. Then, the predetermined portion 74 is rotated to pivot the elongated member 72 and move the holding pawl 60 away from engagement with the ratchet means 46. Next, the holding pawl 60 is maintained in such disengaged position while the handle 30 or the knob 34 are rotated to discharge fluid form the hydraulic cylinder 22 enabling lowering of the load (not shown). The predetermined portion 74 is then released causing the holding pawl 60 to reengage the ratchet means 46 due to gravity or due to force from the bias spring 64.

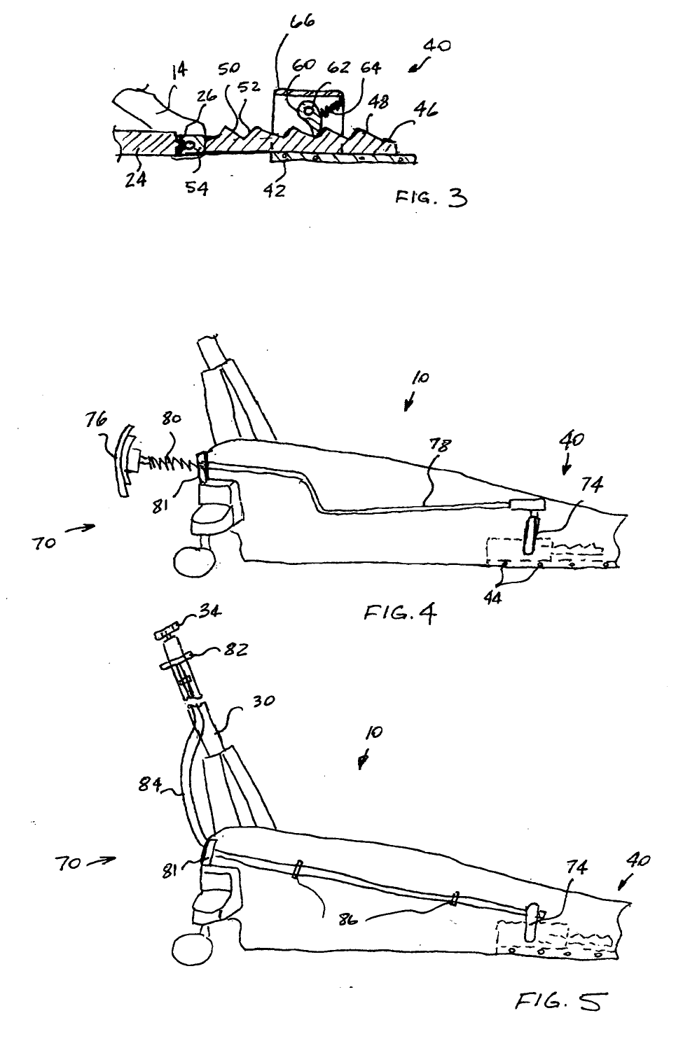

To remotely release the locking device 40, in one embodiment, best shown in FIG. 4, the release means 70 may be provided with a pedal means 76 connected to the predetermined portion 74 with the linkage 78, which is preferably a cable 78, and biased by the bias spring 80 for maintaining engagement of the holding pawl 60 with the ratchet means 46. The spring 80 is caged between the pedal 76 and the stop 81 which may be attached or integral to one of the pair of side plates 12. Advantageously, such pedal means 76 is foot operated.

In another embodiment, best shown in FIG. 5, the release means 70 may be provided with a release handle 82 disposed adjacent an open end of such handle 30 and connected to the predetermined portion 74 with a linkage 82, which is preferably a cable 84, secured to the jack 10 with a plurality of retaining clips 86. Movement of the release handle 82 in one direction causes pivoting of the predetermined portion 74 and shaft 62 and movement of the holding pawl 60 away from engagement with the ratchet means 46.

The presently preferred material of the locking device 10 is a metal.

It will be understood that during retrofit of the presently used hydraulic floor jack 10 with the locking device 40 of the present invention, the pair of side plates 12 are drilled and the base member 40 is attached to both side plates 12 with fasteners 44. The mounting portion 54 of the ratchet means 46 is attached to the piston rod 24 with the retaining pin 26 and to the linkage means 14 with the pair of retaining clips 27 after removal of the member 18. One of the side plates 12 is drilled to accept the elongated member 72 and the stop 81 is added to accommodate pedal 76 or the release handle 82, which are then connected to the protruding portion 74 of such elongated member 72.

Although the present invention has been shown in terms of the hydraulically operable floor jack, it will be apparent to those skilled in the art, that the present invention may be applied to other jack types and operating drive mechanisms requiring support of the elevated load independently from the force provided by such operating drive mechanism.

It will be further apparent that an electrically operated solenoid of a fluid operated valve may be provided for moving the holding pawl from engagement with the ratchet means.

The holding pawl may be mounted for linear movement in a direction perpendicular to a longitudinal axis of the ratchet means when the release mechanism is adapted to force the holding pawl into and from engagement with the ratchet means.

Furthermore, a rigid linkage may be provided for remotely engaging and disengaging holding pawl. Advantageously such rigid linkage will aid in biasing such holding pawl for engagement with the ratchet means.

Additionally, a friction clutch or a screw driven locking device may be used instead of the ratchet and holding pawl arrangement for retaining the load in the elevated position.

Thus, the present invention has been described in such full, clear, concise and exact terms as to enable any person skilled in the art to which it pertains to make and use the same. It will be understood that variations, modifications, equivalents and substitutions for components of the specifically described embodiments of the invention may be made by those skilled in the art without departing from the spirit and scope of the invention as set forth in the appended claims.

I claim:

1. A locking device for a load lifting jack having a pair of spaced side plates, a linkage means supported and disposed for pivotal movement between such pair of side plates, such linkage means movable from a lowered position to an elevated position for engaging and elevating such load, a drive means connected to such linkage means for moving such linkage means towards such elevated position upon actuation of such drive means and for moving such linkage means towards such lowered position upon deactuation of such drive means, and a manually operable control means for actuating and deactuating such drive means, said locking device comprising:
(a) a base member attached to such pair of spaced side plates;
(b) a retaining means having a predetermined portion thereof mounted for linear movement within such jack, said retaining means operable for retaining such linkage means in such elevated position upon termination of a manual actuating effort and for preventing movement of such linkage means into such lowered position upon deactuation of such drive means; and
(c) a release means engageable with said retaining means for releasing said retaining means and enabling movement of such linkage means into such lowered position.

2. The locking device, according to claim 1, wherein said retaining means includes a ratchet means mounted for linear movement within said base member and engageable with one of a predetermined portion of such drive means, such linkage means and a combination thereof for movement therewith, a shaft member pivotally mounted to one of said base member and such pair of side plates, and a holding pawl secured to said shaft for rotation therewith and engageably cooperative with said ratchet means for at least retaining such linkage means in such elevated position upon termination of said manual actuating effort.

3. The device, according to claim 2, wherein said release means includes an elongated member extending from said shaft for at least moving said holding pawl away from engagement with said ratchet means and enabling movement of such linkage means into such lowered position.

4. The locking device, according to claim 3, wherein said elongated member includes a predetermined portion thereof protruding beyond such at least one of such pair of spaced side plates.

5. The locking device, according to claim 4, wherein said release means further includes a foot operated pedal disposed adjacent such drive means and connected to said protruding predetermined portion of said elongated member, whereby actuation of said pedal causes pivoting of said elongated member and movement of said holding pawl away from engagement with said ratchet means.

6. The locking device, according to claim 5, wherein said release means further includes a bias spring caged between said pedal and a stop connected to such jack for urging said pedal into position enabling engagement of said holding pawl with said ratchet means.

7. The locking device, according to claim 4, wherein said release means further includes a release handle disposed adjacent an open end of such manually operable control means and connected to said predetermined protruding portion of said elongated member, whereby movement of said release handle in one direction causes pivoting of said elongated member and movement of said holding pawl away from engagement with said ratchet means.

8. The locking device, according to claim 2, wherein said locking device includes a bias means for urging said holding pawl into engagement with said ratchet means.

9. The locking device, according to claim 2, wherein said ratchet means includes an elongated rack having a predetermined plurality of teeth each defined by a sloped front surface and a substantially vertical back surface and said holding pawl abuts said substantially vertical back surface when such linkage means is moved to such elevated position.

10. The locking device, according to claim 1, wherein such drive means includes a hydraulic cylinder having a piston member mounted for linear movement therein and a piston rod attached to said piston member and extending outwardly from such hydraulic cylinder for connection to such linkage means and a pump assembly connected in fluid communication with such hydraulic cylinder and removably connected to such manually operable control means, whereby a first predetermined manual operation of such control means delivers fluid from such pump assembly to such hydraulic cylinder, generating fluid pressure onto such piston and causing movement of such piston rod in a first direction and enabling movement of such linkage means to such elevated position, and whereby a second predetermined manual operation of such control means discharges such fluid from such hydraulic cylinder causing movement of such piston rod in a second direction and enabling movement of such linkage means to such lowered position.

11. The locking device, according to claim 1, wherein a material of said locking device is metal.

12. A locking device for a jack having a pair of spaced side plates, a linkage means supported and disposed for pivotal movement between such pair of side plates, such linkage means movable from a lowered position to an elevated position for engaging and elevating a load, a drive means connected to such linkage means for moving such linkage means towards such elevated position upon actuation of such drive means and for moving such linkage means towards such lowered position upon deactuation of such drive means, and a manually operable control means for actuating and deactuating such drive means, said locking device comprising:
(a) a base member attached to such pair of spaced side plates;
(b) a ratchet means mounted within said base member and engageable with one of a predetermined portion of such drive means, such linkage means and a combination thereof for movement therewith;
(c) a shaft member pivotally mounted to one of said base member, such pair of side plates and a combination thereof;
(d) a holding pawl secured to said shaft for rotation therewith and engageably cooperative with said ratchet means for retaining such linkage means in such elevated position upon termination of a manual actuating effort; and
(e) a release means operable to at least move said holding pawl away from engagement with said ratchet means and enable movement of such linkage means into such lowered position.

13. A jack comprising a pair of spaced side plates, a linkage means supported and disposed for pivotal movement between said pair of side plates, said linkage means movable from a lowered position to an elevated position for engaging and elevating a load, a drive means connected to said linkage means for moving said linkage means towards said elevated position upon actuation of said drive means and for moving said linkage means towards said lowered position upon deactuation of said drive means, a manually operable control means for actuating and deactuating said drive means, and a locking means for at least retaining said linkage means in said elevated position upon termination of a manual actuating effort, said locking means including at least a ratchet means engageable with one of said drive means, said linkage means and a combination thereof and a holding pawl engageably cooperative with said ratchet means for preventing movement of said linkage means into said lowered position upon deactuation of said drive means.
